(19) United States
(12) Patent Application Publication
(10) Pub. No.: US 2006/0169419 A1
(43) Pub. Date: Aug. 3, 2006

(54) Transmission apparatus for opening and closing slats of an electric blind

(76) Inventor: Li-Ming Cheng, Kaohsiung City (TW)

Correspondence Address: BIRCH STEWART KOLASCH & BIRCH, PO BOX 747, FALLS CHURCH, VA, 22040-0747, US

(21) Appl. No.: 11/048,709

(22) Filed: Feb. 3, 2005

(51) Int. Cl. E06B 9/32

(52) U.S. Cl. 160/168.1 P

(57) ABSTRACT

A transmission apparatus for opening and closing slats of an electric blind includes a frame which has a housing compartment and a transmission device held in the housing compartment. The transmission device has a transmission shaft coupled with a motor spindle through a flexible tube which has a first sleeve and a second sleeve on the left end and the right end such that loading of the motor may be reduced and the axes of the transmission shaft and the motor spindle may be coupled even when they are not aligned accurately, thereby the electric blind can open and close the slats as desired.

### FIELD OF THE INVENTION

The present invention relates to an improved transmission apparatus for opening and closing slats of an electric blind and particularly to a transmission apparatus capable of coupling a motor spindle and a transmission shaft even when their axes are not accurately aligned.

### BACKGROUND OF THE INVENTION

A conventional blind, referring to FIGS. 1 and 2, generally has a frame B with a housing compartment to hold a transmission device A. The transmission device A has a gear set A1 on one side. The gear set A1 is sandwiched by a front cover A2 and a rear cover A3 of a case. The gear set A1 has an axle A10 running through a corresponding axle hole A20 formed on the front cover A2. A transmission shaft A4 runs through other side of the axle hole A20. The transmission shaft A4 and the axle A10 of the gear set A1 are located on the same straight line and coupled together to prevent the motor from overloading.

The slats D of the conventional blind are dragged by hanging ropes C1 and C2 that are driven by turning of a tilt rod C located outside the frame B. The movement of the hanging ropes C1 and C2 moves the slats D to close or open (referring to FIG. 3). As the opening and closing of the slats D are driven by the transmission shaft A4, the transmission shaft A4 has to bear the force for opening and closing the slats D, and is easily deformed. As a result, the axis of the transmission shaft A4 cannot always align with the axis of the axle A10 of the gear set A1 on the same straight line. Coupling of the transmission shaft A4 and the axle A10 is not accurate. And the operation of the transmission shaft A4 could result in overload of the motor, and opening and closing of the slats D will be affected and become less desirable

### SUMMARY OF THE INVENTION

In view of the aforesaid disadvantages occurred to the conventional electric blinds, the primary object of the invention is to provide an improved transmission apparatus for opening and closing slats of an electric blind that has a flexible tube with a sleeve respectively on a left end and a right end to couple with a motor spindle and a transmission shaft so that the motor spindle and the stem of the transmission shaft are inserted into the center holes of the sleeves on two sides of the flexible tube. Thus coupling can be achieved even if the axes are not aligned accurately. Therefore the electric blind can perform opening and closing of the slats in addition to the original function of pulling up and dropping down. It can overcome the problems of defective coupling between the transmission shaft and motor spindle caused by deformation of the transmission shaft, and motor overload may be avoided to prevent breakdown of the entire transmission device.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional blind.

FIG. 2 is a perspective view according to FIG. 1 showing a coupling condition between a transmission shaft and the axle of a gear set.

FIG. 3 is a side view according to FIG. 1 showing the blind is closed by turning of a tilt rod.

FIG. 4 is a perspective view of the invention.

FIG. 5 is an exploded view of the invention.

FIG. 6A is a top view of the invention.

FIG. 6B is a schematic view according to FIG. 6A showing the transmission apparatus.

FIG. 7 is a side view of the electric blind of the invention in a closed condition.

FIG. 8 is a schematic view of the invention showing the transmission shaft of the transmission apparatus being coupled with the motor spindle in a condition of not-aligned axes.

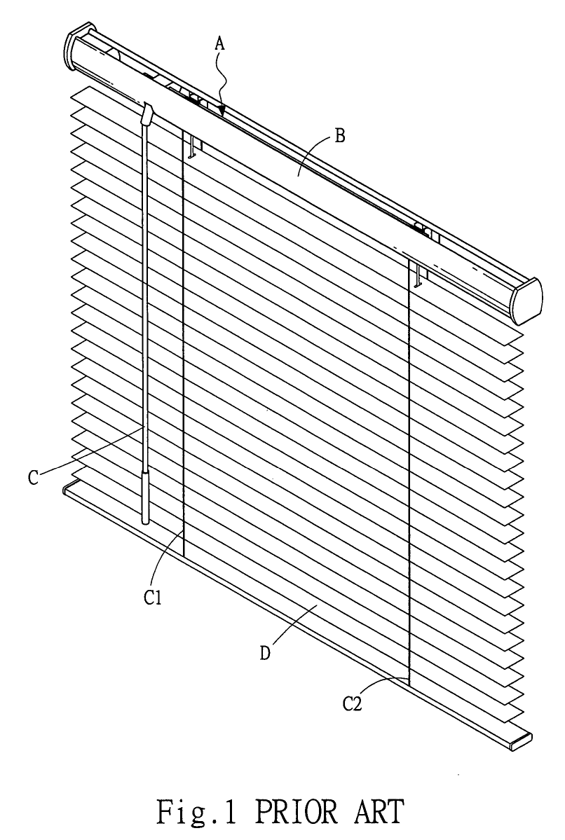

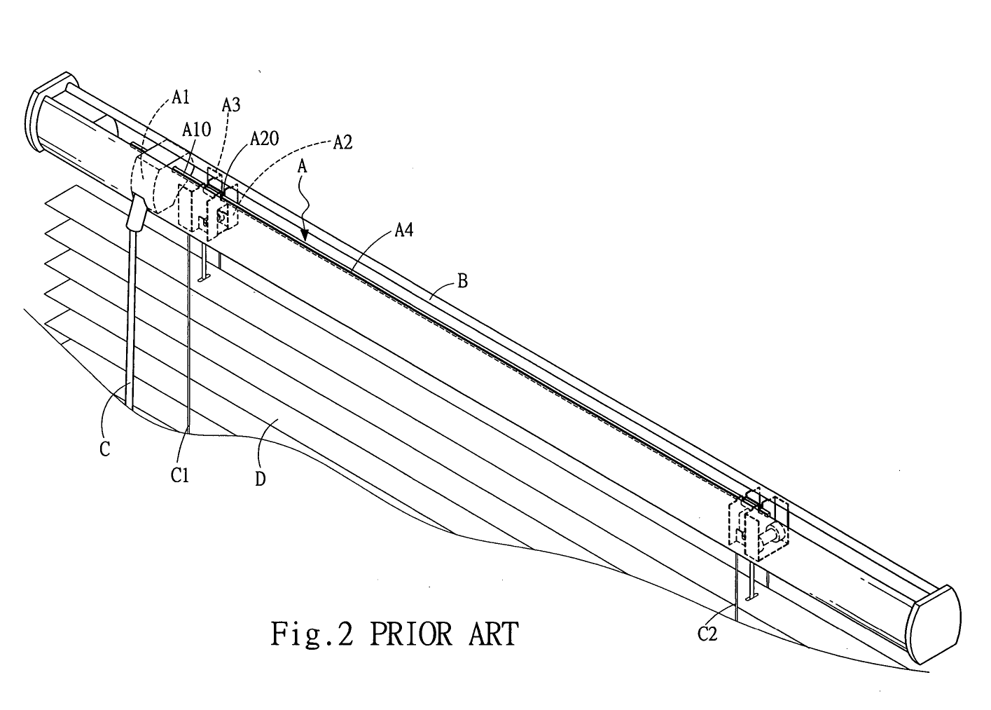

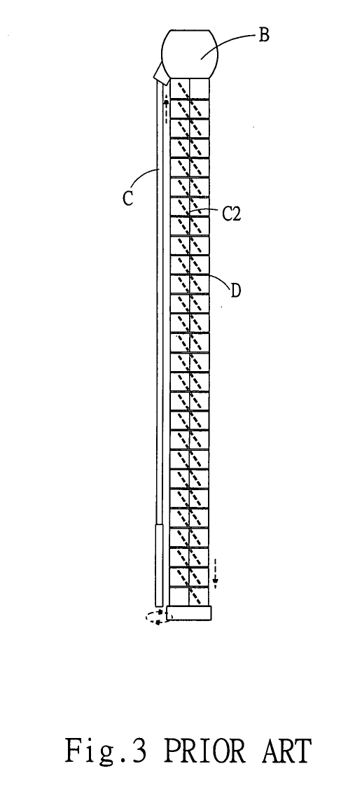

### DETAILED DESCRIPTION OF THE PREFERRED EMBODIMENT

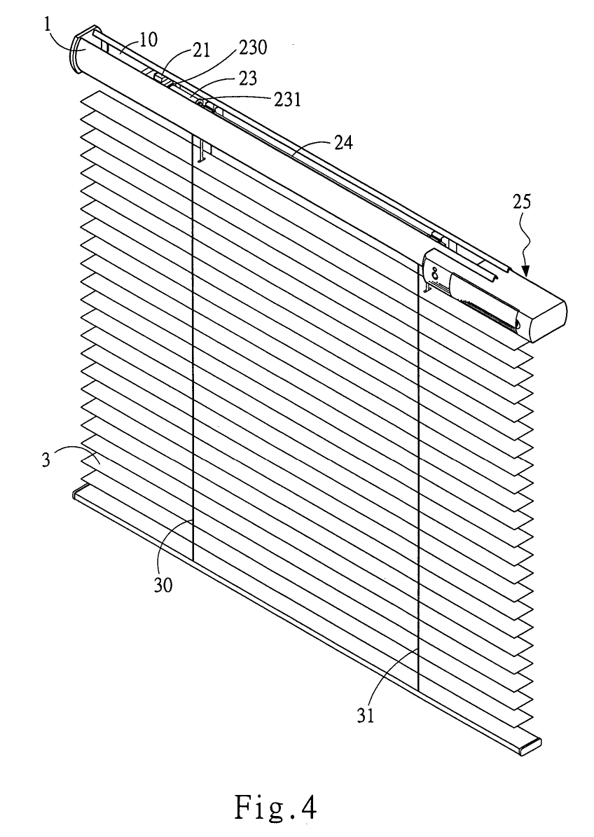

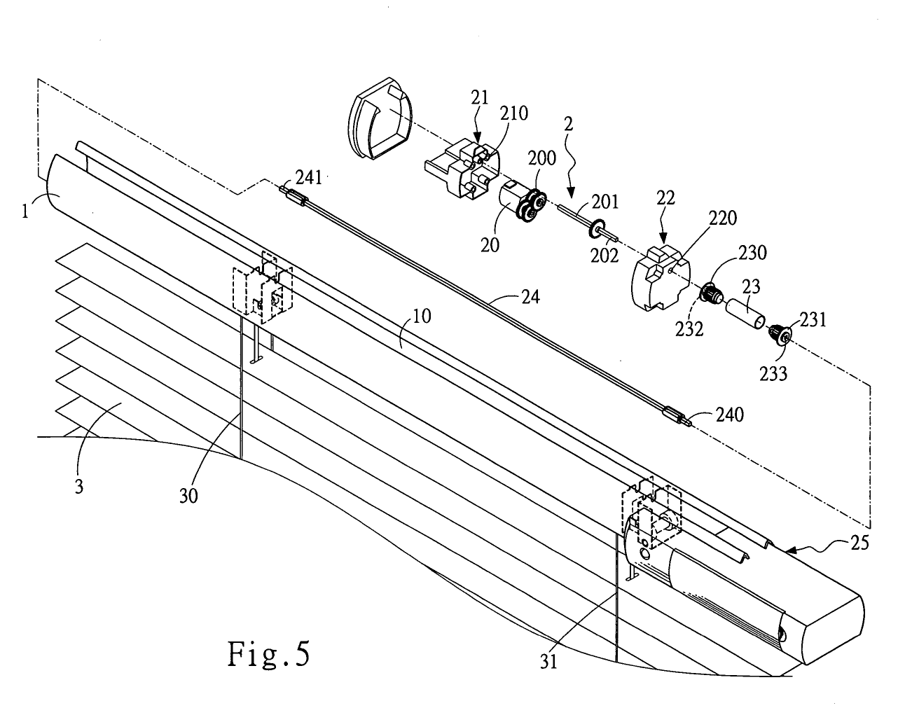

Please referring to FIGS. 4 and 5, the improved transmission apparatus for opening and closing slats of an electric blind according to the present invention includes a frame 1 which has a housing compartment 10 to hold a transmission device 2.

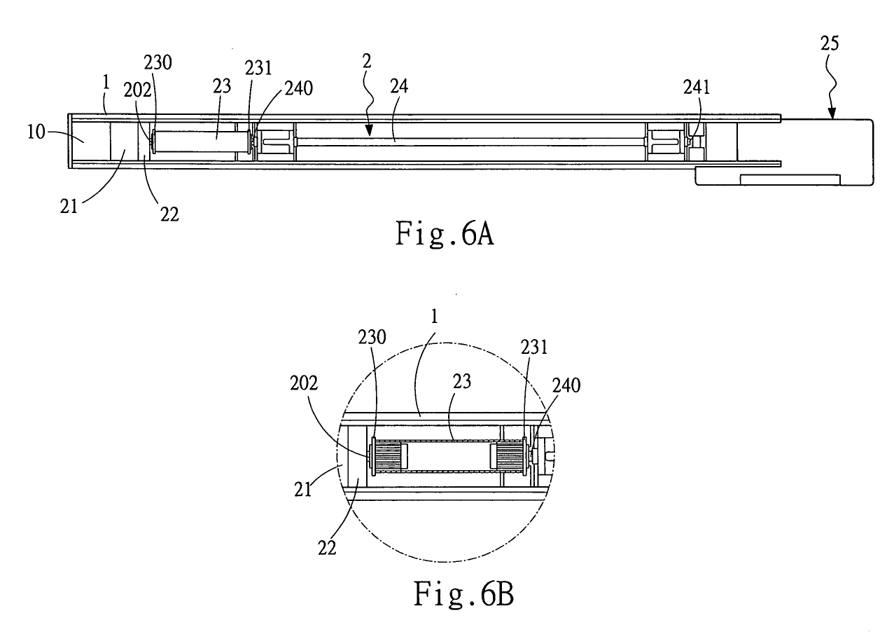

The transmission device 2 includes a change gear 200 and a motor 20 which has a spindle with a first end 201 on one side and a second end 202 on other side. The motor 20 has a left end and a right end engaged with a rear cover 21 and a front cover 22 of a case. The rear cover 21 and the front cover 22 have respectively a first axle hole 210 and a second axle hole 220 corresponding to the first end 201 and second end 202 of the motor spindle for alignment. The second axle hole 220 faces a flexible tube 23 which has two ends coupled respectively with a first sleeve 230 and a second sleeve 231. The sleeves 230 and 231 have respectively a first center hole 232 and a second center hole 233 on an outer side. The first center hole 232 is coupled with the second end 202 of the motor spindle. The first center hole 231 is coupled with a first stem 240 of a transmission shaft 24. The transmission shaft 24 has a second stem 241 pivotally coupled with a battery box 25. Therefore, the first spindle end 201 runs through the first axle hole 210, while the second spindle end 202 runs through the second axle hole 220 and is coupled with the first center hole 232 of the first sleeve 230. The first stem 240 runs through the second center hole 233 of the second sleeve 231. Hence the second spindle end 202 of the motor spindle and the transmission shaft 24 are bridged by the flexible tube 23 that has two ends coupled with the sleeves 230 and 231. Therefore, even if the axis of the transmission shaft 24 is not aligned on a straight line during transmission, the transmission shaft 24 can still be coupled with the second end 202 of the motor spindle to perform transmission function, and the overload condition of the motor 20 may be avoided (referring to FIGS. 6A and 6B).

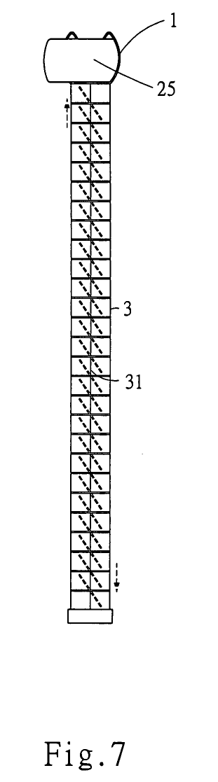

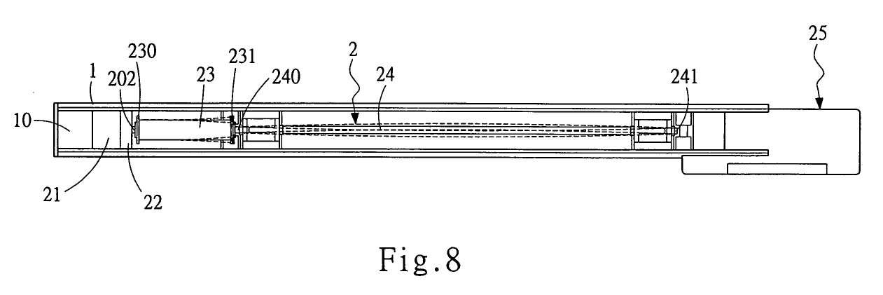

Referring to FIGS. 7 and 8, when the electric blind of the invention is in use to open or close the slats, the transmission shaft 24 drives the hanging ropes 30 and 31 to move the slats 3 to open or close. The transmission shaft 24 is dragged by the slats, thus the rotation axis could be not aligned with the second spindle end 202 of the motor 20 on the same straight line, and the transmission shaft 24 could skew and not position on the same horizontal level with the second spindle end 202. However, because they are coupled through the sleeves 230 and 231 of the flexible tube 23, the axes of deformed transmission shaft 24 and the second end 202 of the motor spindle can still be maintained on a transmission reference line and coupled. Thus synchronous transmission can be achieved, and motor overload can be prevented. And the electric blind can still perform opening and closing of the slats 3.

What is claimed is:

1. A transmission apparatus for opening and closing slats of an electric blind, comprising a frame which has a housing compartment and a transmission device held in the housing compartment;
wherein the transmission device has a transmission shaft coupled with a spindle of a motor through a flexible tube which has a left end and a right end coupled respectively with a first sleeve and a second sleeve, such that loading of the motor is reduced and the axes of the transmission shaft and the motor spindle are coupled even when they are not aligned accurately thereby to allow the electric blind to open and close the slats as desired.

2. The transmission apparatus of claim 1, wherein the flexible tube is hollow.

3. The transmission apparatus of claim 1, wherein the first sleeve and the second sleeve have respectively a center hole.
